(19) United States
(12) Patent Application Publication
(10) Pub. No.: US 2011/0303540 A1
(43) Pub. Date: Dec. 15, 2011

(54) PHOTO-CATALYST OZONE DETECTOR

(76) Inventors: Feng-Tsun HUANG, Taichung City (TW); Chao-Yang Huang, Taichung City (TW); Ming-Hung Chen, Taichung City (TW); Ren-Jang Wu, Taichung City (TW)

(21) Appl. No.: 13/216,263

(22) Filed: Aug. 24, 2011

Related U.S. Application Data
(63) Continuation-in-part of application No. 12/243,946, filed on Oct. 1, 2008, now abandoned.

(51) Int. Cl. G01N 27/30

(52) U.S. Cl. 204/416

(57) ABSTRACT

A photo-catalyst ozone detector includes a base. A positive electrode and a negative electrode are respectively disposed on the base. A photo-catalyst coating is disposed on the base for connecting the positive electrode and the negative electrode, and reacting with the ozone to detect ozone consistency, wherein the photo-catalyst coating contains titanium dioxide.

### CROSS-REFERENCE TO RELATED APPLICATION

This application is a Continuation-In-Part Application of Ser. No. 12/243,946, filed 1 Oct. 2008, and entitled “PHOTO-CATALYST OZONE DETECTOR”, now pending.

### BACKGROUND OF THE INVENTION

1. Field of the Invention

The present invention relates to an ozone detector, and more particularly to a photo-catalyst ozone detector that has a photo-catalysis coating containing titanium dioxide.

2. Description of Related Art

As well known, the atmosphere contains oxygen, nitrogen and some rare gas, wherein one of the rare gases (ozone) is concerned about the present invention. The ozone is an intense oxidizer that can eliminate virus, bacteria, spores and fungus such that the ozone can be used for air purification.

The ozone provides the above effects and is not harmful to human body under a specific consistency. However, the ozone is harmful to the human body and the environment when it has a high consistency such that the control of the consistency of the ozone is very importance. As a result, some ozone detectors are patented and marketed.

As regard to EP1219957—ELECTRONIC TONGUE AS OZONE DETECTOR by Ekberg, the electronic tongue is provided for liquid state material. The detecting material is in a liquid state or previously processed to the liquid state. Ekberg discloses a detecting electrode inserted into the detecting material, and having a positive electrode and a negative electrode that are adjacent to each other and not electrically connected to each other. Ekberg uses the voltammetry to calculate the ozone consistency by using the variation of the resistance of the electrolyte in the solution. The prerequisite condition of the detector disclosed by Ekberg is an electrode that has a stable resistance value and is uneasily eroded. However, the detector disclosed by Ekberg is only used to the material that must be in a liquid state, that is, the detector of Ekberg can not directly detecting the ozone in the air such that the detecting scope is limited. Furthermore, the consistency of the ozone may be change to the solution, especially when the consistency of the ozone is low.

As regard to the Taiwan Pat. No. 559658 by Wu who discloses a method for detecting the consistency of ozone and the system thereof, Wu adds ethylene with known consistency into the ozone with unknown consistency. According to the chemical formula:

C₂H₄+O₃→HCHO+CH₂OO,

the consistency of the reacted ethylene is detected after being reacted and the detected value of the reacted ethylene is used to derive the consistency of the ozone. However, the ethylene is an active gas such that a certain dangerous is existed when using the ethylene and expended such that the detecting cost is raised. In addition, the method, disclosed by Wu, takes a period of time for waiting the ozone and the ethylene fully reacted. It is inconvenient. Furthermore, this method also can not directly detect the consistency of the ozone.

As regard to U.S. Pat. No. 7,069,769 by Kung who that discloses an ultraviolet photoacoustic ozone detection, in that, Kung discloses that the detection uses ultraviolet and acoustic frequency for detecting the consistency of ozone. Kung provides a casing with a detecting space for containing ozone and an ultraviolet passing through the detecting space, wherein the ultraviolet has a resonance frequency the same as that of the detecting space. A receiver is provided to receive the acoustic frequency for calculating the consistency of the ozone. However, the size of the detecting space must accurately correspond to the resonance of the ultraviolet. The casing is hard to be accurately made. Furthermore, there is a problem needs to be overcome, that is, the casing may expand when hot and shrink when cold. There are too many variables in the detection disclosed by Kung. Consequently, the consistency of the ozone is hard to be accurately detected.

The present invention has arisen to mitigate and/or obviate the disadvantages of the conventional detections for ozone.

### SUMMARY OF THE INVENTION

The main objective of the present invention is to provide an improved photo-catalyst ozone detector that has a photo-catalysis coating containing titanium dioxide for repeatedly operation.

To achieve the objective, the photo-catalyst ozone detector in accordance with the present invention comprises a base including a positive electrode and a negative electrode respectively disposed thereon. The base is made of alumina and has two conducting portions disposed on the base. The two conducting portions are comb-shaped and do not directly electrically connected to each other. Each conducting portion has a front end and a rear end. A photo-catalyst coating is prepared as a paste for painting on the base and encloses the front end of each of the two conducting portions such that the two conducting portions are connected by the photo-catalyst coating. The photo-catalyst coating contains overwhelming majority of titanium dioxide (TiO₂). In another embodiment of the present invention, the titanium dioxide is mixed with a bit of tin dioxide (SnO₂) or tungsten trioxide (WO₃). In addition, the titanium dioxide can be previously mixed with gold or platinum in a ratio 1:1. The mixed titanium dioxide and gold or platinum is further mixed with tin dioxide or tungsten trioxide in a ratio 1:4. In the preferred embodiment of the present invention, the photo-catalyst coating contains titanium dioxide that is sequentially with platinum and tin dioxide in the ratio, hereinbefore.

The photo-catalyst coating is reacted and the resistance thereof is changed due to the consistency of ozone. However, the resistance of the photo-catalyst coating is always over KΩ such that the resistances of the positive electrode, the negative electrode and the conducting portions are next to nothing relative to that of the photo-catalyst coating. Furthermore, the photo-catalyst coating can be restored by being illuminated with ultraviolet or LED for repeated operations.

Further benefits and advantages of the present invention will become apparent after a careful reading of the detailed description with appropriate reference to the accompanying drawings.

### BRIEF DESCRIPTION OF THE DRAWINGS

FIG. 1 is a plan view of a photo-catalyst ozone detector in accordance with the present invention;

FIG. 2 is a schematic view of the ozone detector in FIG. 1, wherein a processing device and a consistency detecting device are respectively connected to the ozone detector;

FIG. 3 is an impedance response-to-ozone consistency coordinate graph in accordance with the present invention;

FIG. 4 is a response time-to-ozone consistency coordinate graph in accordance with the present invention;

FIG. 5 is a resistance-to-times coordinate graph in accordance with the present invention; and

FIG. 6 is a resistance-to-times coordinate graph in accordance with the present invention.

### DETAILED DESCRIPTION OF THE INVENTION

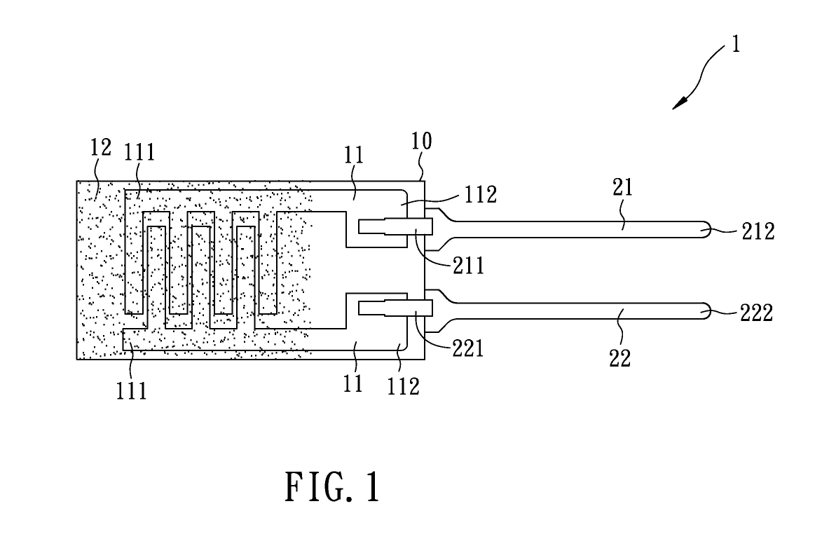

Referring to the drawings and initially to FIGS. 1-4, a photo-catalyst ozone detector (1) in accordance with the present invention is used to measure a concentration of ozone in a detecting gas sample (not shown). The photo-catalyst ozone detector (1) comprises a base (10) including a positive electrode (21) and a negative electrode (22) respectively disposed thereon.

In the preferred embodiment, the base (10) is made of alumina (Al₂O₃) and has two conducting portions (11) disposed on the base (10). The two conducting portions (11) are comb-shaped and do not directly electrically connected to each other. The two conducting portions (11) are in an interdigital arrangement. Each conducting portion (11) has a front end (111) and a rear end (112). A photo-catalyst coating (12) is disposed on the base (10) and encloses the front end (111) of each of the two conducting portions (11) such that the two conducting portions (11) are connected by the photo-catalyst coating (12). By the way, the photo-catalyst coating (12) is prepared as a paste for adhering to the base (10) here. Therefore, the photo-catalyst (12) can easily adhere to the base (10) by painting rather than using the sputtering or the chemical vapor deposition in which the equipment is very expensive. The photo-catalyst coating (12) contains overwhelming majority of titanium dioxide (TiO₂). In another embodiment of the present invention, the titanium dioxide is mixed with a bit of tin dioxide (SnO₂) or tungsten trioxide (WO₃). In addition, the titanium dioxide can be previously mixed with gold or platinum in a ratio 1:1. The mixed titanium dioxide and gold or platinum is further mixed with tin dioxide or tungsten trioxide in a ratio 1:4. In the preferred embodiment of the present invention, the photo-catalyst coating (12) contains titanium dioxide that is sequentially with platinum and tin dioxide in the ratio, hereinbefore.

A positive electrode (21) and a negative electrode (22) are respectively electrically connected to a corresponding one of the two conductive portions (11) of the base (10) such that the positive electrode (21) and the negative electrode (22) are not directly connected to each other. Each of the positive electrode (21) and the negative electrode (22) has a first end (211/221) mounted to the base (10) and electrically connected to the corresponding one of the two conductive portions (11) and a second end (212/222) adapted to be electrically to processing device (30) such that the positive (21) and the negative electrode (22) are indirectly connected to each other via the photo-catalyst coating (12).

The photo-catalyst coating (12) is reacted and the resistance thereof is changed due to the consistency of ozone. However, the resistance of the photo-catalyst coating (12) is always over KΩ such that the resistances of the positive electrode (21), the negative electrode (22) and the conducting portions (11) are next to nothing relative to that of the photo-catalyst coating (12). Furthermore, the photo-catalyst coating (12) can be restored by being illuminated with ultraviolet or LED for repeated operations. In the preferred embodiment of the present invention, the ultraviolet is selected.

The photo-catalyst ozone detector (1) in accordance with the present invention can be further connected to a processing device (30), such as a computer, which is capable of calculating the variation of resistance value. The processing device (30) has an amplify circuit disposed therein for being coupled with a micro current the passing the resistance with a high resistance value. The processing device (30) records the impedance response (variation of the resistance value) after the photo-catalyst ozone detector being situated in an environment filled with ozone. A high positive correlation is kept between the impedance response and the consistency of the ozone such that the photo-catalyst ozone detector of the present invention can be directly used for detecting the consistency of the ozone and provides an accurate detect effect.

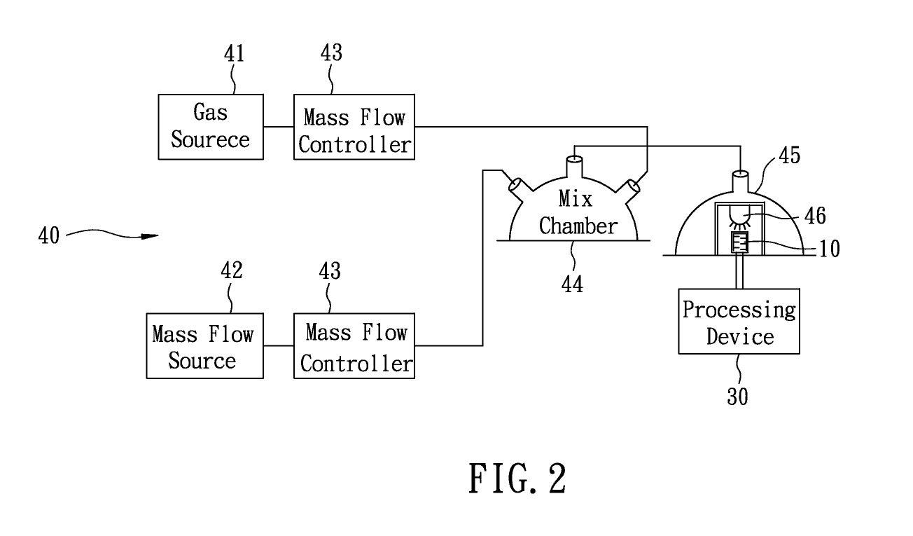

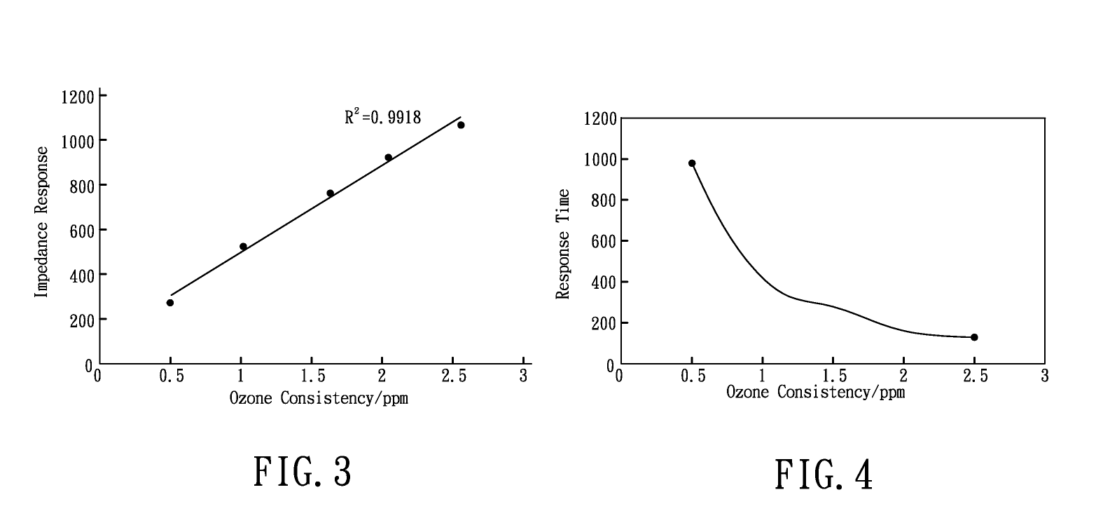

With reference to FIG. 2 that is a schematic view of the photo-catalyst ozone detector that is connected to the processing device (30) and a consistency detecting device (40) that is provided to experiment the accuracy and response time. The experiment results are shown in FIGS. 3-6.

The consistency detecting device (40) includes detecting chamber (45) for receiving the base (10) and an ultraviolet emitter (46) mounted in the detecting chamber (45) for restoring the photo-catalyst coating (12) on the base (10). A mix chamber (44) communicates with the detecting chamber (45) for providing the mixed gas with ozone into the detecting chamber (45). An ozone source (42) and a gas source (41) are respectively connected to the mix chamber (44), wherein the gas source (41) provides the gas into the mix chamber (44) for diluting the ozone from the ozone source and the gas from the gas source (41) does not react with the ozone. Two mass flow controllers (43) are respectively mounted between the mixing chamber (44) and the ozone source (42), and the mixing chamber (44) and the gas source (41) for controlling the ozone consistency in the mix chamber (44).

### EXPERIMENT 1

FIG. 3 shows the positive correlation between the impedance response and the consistency of the ozone, and FIG. 4 shows the relation analysis between the consistency of the ozone and the response time. The mass flow controllers (43) are respectively operated to mix the ozone in mix chamber (44) to the following consistencies: 0.5 ppm, 1.02 ppm, 1.64 ppm, 2.04 ppm and 2.5 ppm. The various mixed gases with different consistencies are previously and respectively prepared for detecting and recording.

The gases with different consistencies are sequentially and respectively guided into the mix chamber (44), and reacted with the photo-catalyst coating (12) of the photo-catalyst ozone detector (1) in accordance with the present invention. The processing device (30) respectively calculates the resistance variation of the photo-catalyst coating (12) and the calculating results are shown in FIG. 3. The impedance responses respectively are 268.28 KΩ, 520.63 KΩ, 784.13 KΩ, 926.98 KΩ and 1071.40 KΩ when the ozone consistencies respectively are 0.5 ppm, 1.02 ppm, 1.64 ppm, 2.04 ppm and 2.55 ppm.

As shown in FIG. 3, the X-axis is the ozone consistency and the Y-axis is the impedance response. The above results correspond to five points in FIG. 1 relative to the X-axis and the Y-axis. To analyze the positive correlation of the five points by statistical method will get that R²=0.9918. The R² is very closed to one, that is, an accurate correlation is retained between the ozone consistency the impedance formed by the photo-catalyst ozone detector (1) of the present invention. Consequently, the accuracy of detecting the ozone consistency is effectively promoted by using the photo-catalyst ozone detector (1) in accordance with the present invention.

As shown in FIG. 4, the X-axis is the ozone consistency and the Y-axis is the response time. As regard to the tendency as shown in FIG. 4 by using the above results, the response time becomes short when the ozone consistency becomes thick.

### EXPERIMENT 2

The records of the resistance value when the ozone consistency is 2.5 ppm:

The detecting gas with 2.5 ppm ozone is previously mixed in the mix chamber (44) by controlling the two mass flow controllers 43. The impedance response of the photo-catalyst ozone detector (1) of the present invention is recorded by the processing device (30) at a fixed time.

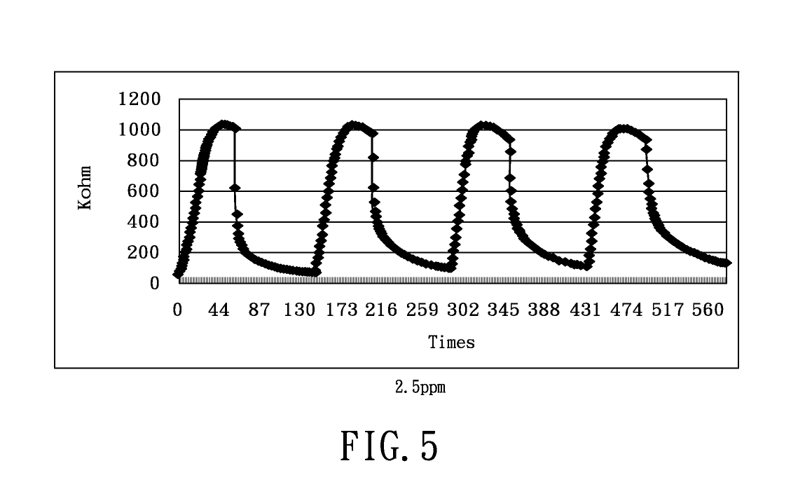

As shown in FIG. 5, the X-axis is the record times at a fixed time and the Y-axis is the resistance value. At the beginning, the resistance value is quickly raised after the photo-catalyst coating (12) reacting with the ozone when the ozone consistency is 2.5 ppm. The resistance value is slightly undulated after being raised about 1066 KΩ near the maximum thereof. The ultraviolet emitter (46) is operated to illuminate the base (10) for restoring the photo-catalyst coating (12), then the resistance value is quickly reduced near the minimum and the first cycle is finished. The illuminated photo-catalyst coating (12) reacts with the ozone again such that the resistance value is quickly raised and undulated near 1060 KΩ, then the photo-catalyst coating (12) is illuminated by the ultraviolet emitter (46) and restored. As a result, the second cycle is finished. The above steps are repeated four times and the results are recorded as shown in FIG. 5 for proving that the photo-catalyst coating (12) can be repeatedly operated.

### EXPERIMENT 3

The records of the impedance when the ozone consistency is 2.0 ppm:

The detecting gas with 2.5 ppm ozone is previously mixed in the mix chamber (44) by controlling the two mass flow controllers (43). The impedance response of the photo-catalyst ozone detector (1) of the present invention is recorded by the processing device (30) at a fixed time.

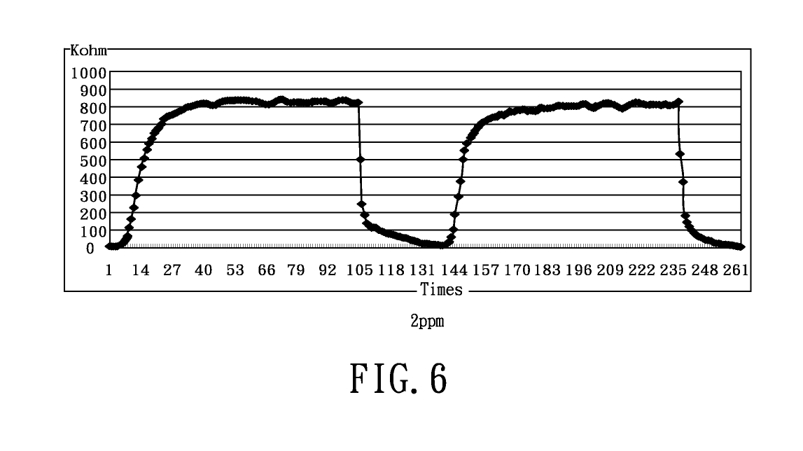

As shown in FIG. 6, the X-axis is the record times at a fixed time and the Y-axis is the resistance value. At the beginning, the resistance value is quickly raised after the photo-catalyst coating (12) reacting with the ozone. However, the raised ratio is slightly slower than that in the experiment 2 because the ozone consistency is thinner than that in the experiment 2. Accordingly, the experiment result in experiment 1 is proved. The resistance value is slightly undulated after being raised about 888 KΩ near the maximum thereof. The ultraviolet emitter (46) is operated to illuminate the base (10) for restoring the photo-catalyst coating (12), then the resistance value is quickly reduced near the minimum and the first cycle is finished. The illuminated photo-catalyst coating (12) reacts with the ozone again and has result similar to that of the first cycle in the experiment 3.

Although the invention has been explained in relation to its preferred embodiment, it is to be understood that many other possible modifications and variations can be made without departing from the spirit and scope of the invention as hereinafter claimed.

What is claimed is:

1. A photo-catalyst ozone detector comprising:
a base;
a positive electrode and a negative electrode respectively disposed on the base;
two conducting portions disposed on the base and being comb-shaped, the two conducting portions being in an interdigital arrangement, the two conducting portions respectively electrically connected to the positive electrode and the negative electrode; and
a photo-catalyst coating being prepared as a paste for painting on the base and connected the two conducting portions therewith for connecting the positive electrode and the negative electrode, the photo-catalyst coating reacting with the ozone to detect ozone consistency in a detecting gas sample, and reducing by being illuminated with Ultraviolet light, wherein the photo-catalyst coating contains titanium dioxide.

2. The photo-catalyst ozone detector as claimed in claim 1, wherein the photo-catalyst coating further contains an element selected from a group consisted of tin dioxide and tungsten trioxide.

3. The photo-catalyst ozone detector as claimed in claim 2, wherein the photo-catalyst coating further contains an element selected from a group consisted of gold and platinum, the gold/platinum previously mixed with the titanium dioxide and then mixed with the tin dioxide/tungsten trioxide.
